(19) United States
(12) Patent Application Publication
(10) Pub. No.: US 2012/0327854 A1
(43) Pub. Date: Dec. 27, 2012

(54) WIRELESS TERMINAL DEVICE, COMMUNICATION CONTROL SYSTEM, AND COMMUNICATION CONTROL METHOD

(75) Inventor: Masaya Kawakita, Kanagawa (JP)

(73) Assignee: KYOCERA CORPORATION, Kyoto (JP)

(21) Appl. No.: 13/530,553

(22) Filed: Jun. 22, 2012

(30) Foreign Application Priority Data
Jun. 22, 2011 (JP) 2011-138931

(51) Int. Cl. H04W 4/00

(52) U.S. Cl. 370/328

(57) ABSTRACT

A mobile telephone device includes: a communication switching unit for selectively switching communication between an LTE communication system and a CDMA communication system; a connection availability reception unit for receiving connection non-available information in the LTE communication system in a case where connection to a destination is not possible, upon communication initiation being requested in a situation where location registration is performed in the LTE communication system; and a communication initiation processing unit which, after the communication initiation is requested, in a case where the connection non-available information is not received, performs the communication initiation by changing a location registering destination to the CDMA communication system, and in a case where the connection non-available information is received, maintains a state where the location registering destination is the LTE communication system and ends communication initiation processing.

This application is based on and claims the benefit of priority from Japanese Patent Application No. 2011-138931, filed on 22 Jun. 2011, the content of which is incorporated herein by reference.

### BACKGROUND OF THE INVENTION

1. Field of the Invention

The present invention relates to a wireless terminal device, a communication control system, and a communication control method that selectively switch communication systems.

2. Related Art

In recent years, LTE (Long Term Evolution) type communication systems have been introduced as communication systems used by wireless terminal devices such as a mobile telephone device, in addition to Circuit Switched (CS) type communication systems (for example, CDMA).

In addition, a CS-Fallback function has been defined in 3GPP TS 23.272. With this function, it is possible to notify in an LTE communication system a communication arrival request from a CDMA communication system (For example, refer to 3GPP TS 23.272 V10.3.1, “Circuit Switched (CS) fallback in Evolved Packet System (EPS); Stage 2” 2011-04).

Furthermore, when performing voice communication initiation using the CS-Fallback function, an instruction of handdown (handover) from an LTE communication system to a CDMA communication system is transmitted to a wireless terminal device in response to a communication initiation request from the wireless terminal device. The wireless terminal device that received the handdown instruction switches the wireless to a CDMA communication system and then performs normal communication initiation processing.

### SUMMARY OF THE INVENTION

An object of the present invention is to provide a wireless terminal device, a communication control system, and a communication control method that can communicate more comfortably.

The wireless terminal device according to the present invention includes: a communication switching unit for selectively switching communication between a first communication system and a second communication system; a connection information reception unit for receiving connection non-available information in the first communication system in a case where connection to a destination is not possible, upon communication initiation being requested in a situation where location registration is performed in the first communication system; and a communication initiation processing unit which, after the communication initiation is requested, in a case where the connection non-available information is not received, performs the communication initiation by changing a location registering destination to the second communication system, and in a case where the connection non-available information is received, maintains a state where the location registering destination is the first communication system and ends communication initiation processing.

In addition, it is preferable if, upon changing the location registering destination between the first communication system and the second communication system, the communication switching unit receives from a control device of the first communication system that has knowledge of a locational relationship between a first communication area section in the first communication system and a second communication area section in the second communication system, supplementary information for changing a connection counterpart.

In addition, it is preferable if the case where connection to a destination is not possible is a case where a destination telephone number is not valid as a telephone number.

In addition, it is preferable if the case where connection to a destination is not possible is a case where the destination is not registered as a location in the second communication system.

In addition, it is preferable if the case where connection to the destination is not possible is a case where the destination has set a communication arrival refusal.

In addition, it is preferable if the case where connection to the destination is not possible is a case where the destination cannot reply to a call.

In addition, it is preferable if the communication initiation is voice communication initiation.

In addition, it is preferable if the communication initiation is SMS (short message service) transmission.

In addition, it is preferable if the first communication system is of a WiMAX standard, and the second communication system is of a CDMA standard.

In addition, it is preferable if the first communication system is of an LTE standard, the second communication system is of a CDMA standard, and the reception of the supplementary information complies with a CS-Fallback function defined in 3GPP TS 23.272.

The communication control system according to the present invention is a communication control system for connecting between a plurality of wireless terminal devices by selectively switching between a first communication system and a second communication system according to a communication request from a wireless terminal device, including: a determination unit for determining whether or not communication to a destination is possible upon communication initiation being requested from a wireless terminal device that is registered as a location in the first communication system; and a transmission unit which, in a case where it is determined that connection to the destination is not possible by the determination unit, transmits connection non-available information to the wireless terminal device that requested the communication initiation, and in a case where it is determined that connection to the destination is possible, transmits to the wireless terminal device that requested the communication initiation a signal that requests to change the location registering destination to the second communication system.

In addition, it is preferable if the determination unit includes: a first determination unit for determining correctness of a format of a destination telephone number, in a control device of the first communication system that requested the communication initiation; and a second determination unit for determining whether or not connection to the destination is possible according to an inquiry from the control device of the first communication system, in a control device of the second communication system.

In addition, it is preferable if, the second determination unit transmits a calling signal to the destination, and in a case where a response to the calling signal is received, determines that connection to the destination is possible, and in a case where a response to the calling signal is not received, determines that connection to the destination is not possible.

The communication control method according to the present invention is a communication control method in a wireless terminal device, including: a communication switching step of selectively switching communication between a first communication system and a second communication system; a connection information receiving step of receiving connection non-available information in the first communication system in a case where connection to a destination is not possible, upon communication initiation being requested in a situation where location registration is performed in the first communication system; and a communication initiation processing step which, after the communication initiation is requested, in a case where the connection non-available information is not received, performs the communication initiation by changing a location registering destination to the second communication system, and in a case where the connection non-available information is received, maintains a state where the location registering destination is the first communication system and ends communication initiation processing.

According to the present invention, the wireless terminal device can communicate more comfortably.

### BRIEF DESCRIPTION OF THE DRAWINGS

FIG. 1 is an external perspective view of a mobile telephone device according to a first embodiment;

FIG. 2 is a block diagram showing the function of a communication control system according to the first embodiment;

FIG. 3 is a sequence diagram showing a processing flow in the communication control system in a case where voice communication initiation can be performed from the mobile telephone device according to the first embodiment to a terminal at the destination;

FIG. 4 is a sequence diagram showing a processing flow in the communication control system in a case where voice communication initiation cannot be performed from the mobile telephone device according to the first embodiment to the terminal at the destination;

FIG. 5 is a sequence diagram showing a processing flow in the communication control system in a case where voice communication initiation can be performed from the mobile telephone device according to a second embodiment to the terminal at the destination; and

FIG. 6 is a diagram showing conventional voice communication initiation processing.

### DETAILED DESCRIPTION OF THE INVENTION

### First Embodiment

Hereafter, a first embodiment of the present invention will be described. It should be noted that, in the present embodiment, a mobile telephone device 1 will be described as an example of the wireless terminal device.

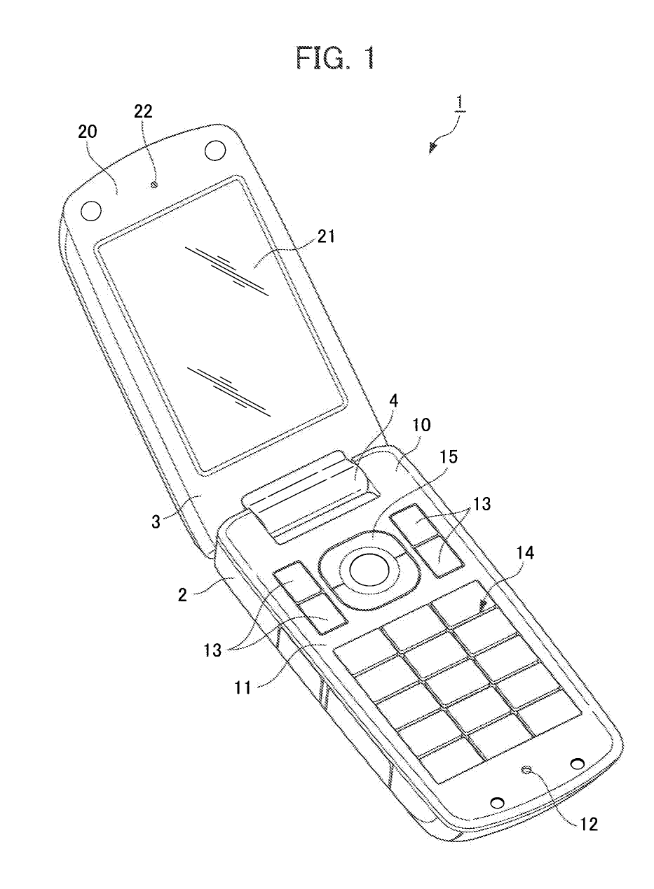

FIG. 1 is an external perspective view of the mobile telephone device 1 according to the present embodiment.

It should be noted that, although FIG. 1 shows an embodiment of a so-called folder type mobile telephone device, the embodiment of the mobile telephone device according to the present invention is not limited thereto. For example, the mobile telephone device may be of: a slider type in which one of the bodies slides to one direction in a state in which the bodies are mutually superimposed; a rotating (turning) type in which one of the bodies is rotated around an axis line along the direction of superimposing bodies; and a type (straight type) in which an operation unit and a display unit are disposed in one body without having a interconnecting portion.

The mobile telephone device 1 is configured to include an operation unit side body 2 and a display unit side body 3. The operation unit side body 2 is configured to include on its surface portion 10 an operation unit 11, and a microphone 12 where voice produced by a user of the mobile telephone device 1 is inputted during a call or during use of a speech recognition application. The operation unit 11 is configured to include: function setting operation buttons 13 for activating various functions, such as various setting functions, a phonebook function, an SMS (short message service) function, and an e-mail function; input operation buttons 14 for inputting digits of a telephone number, characters for an e-mail, or the like; and a determination operation button 15 for performing determinations in various operations, scrolling, or the like.

In addition, the display unit side body 3 is configured to include, on the surface portion 20: a display unit 21 for displaying a variety of information; and a receiver 22 for outputting voice of the other party of the conversation.

In addition, an upper end of the operation unit side body 2 and a lower end of the display unit side body 3 are interconnected via a hinge mechanism 4. Furthermore, by rotating the operation unit side body 2 and the display unit side body 3 relatively to each other, which are interconnected via the hinge mechanism 4, the mobile telephone device 1 can be in a state where the operation unit side body 2 and the display unit side body 3 are opened with respect to each other (opened state), and a state where the operation unit side body 2 and the display unit side body 3 are folded together (closed state).

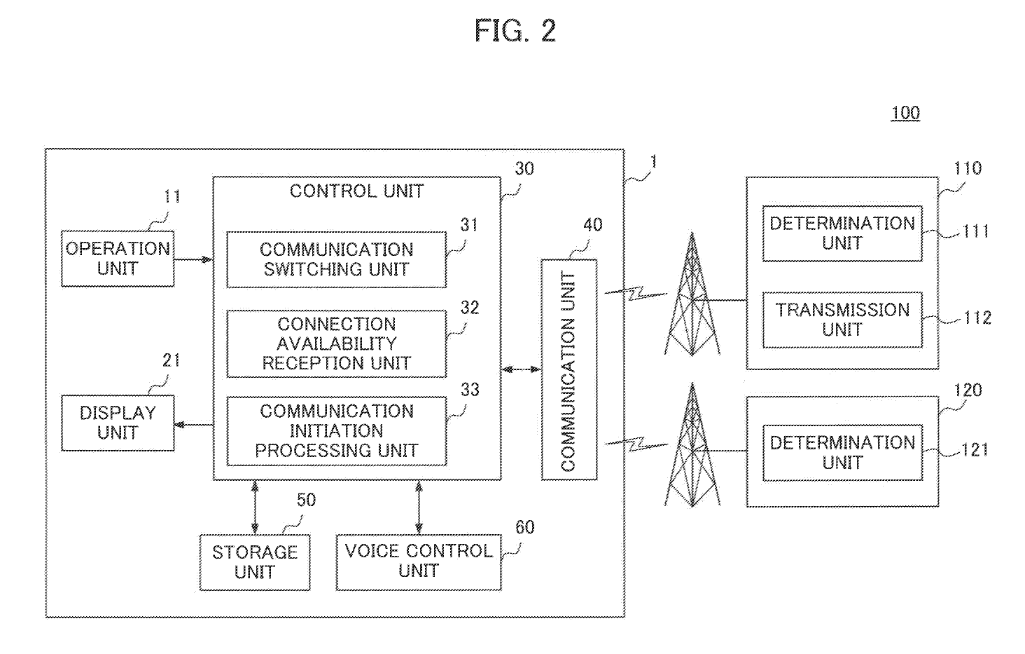

FIG. 2 is a block diagram showing the function of the communication control system 100 including the mobile telephone device 1 according to the present embodiment.

The communication control system 100 includes the mobile telephone device 1, the control device 110 of the LTE communication control system, and the control device 120 of the CDMA communication system. In addition, the mobile telephone device 1 includes the operation unit 11, the display unit 21, the control unit 30, the communication unit 40, the storage unit 50, and the voice control unit 60.

The control unit 30 controls the entire mobile telephone device 1, and for example, performs predetermined control over units such as the display unit 21 and the communication unit 40. In addition, the control unit 30 executes a variety of processing by receiving inputs from the operation unit 11, the communication unit 40, or the like. Moreover, upon executing the processing, the control unit 30 controls the storage unit 50, and reads various programs and data and writes data. It should be noted that the detailed functions of the control unit 30 according to the present embodiment will be described later.

The communication unit 40 communicates with an external device (a base station of the LTE communication system or a base station of the CDMA communication system) using a predetermined frequency band (for example, 2 GHz band and 800 MHz band). Moreover, the communication unit 40 demodulates a signal received from an antenna, and supplies the signal thus processed to the control unit 30, and furthermore modulates the signal supplied from the control unit 30 and transmits the signal from the antenna to the external device.

Here, in the present embodiment, since the communication unit 40 conforms to both W-CDMA or CDMA2000_{—}1x, which is a communication protocol for voice and data communications (hereinafter “CDMA”), and LTE, which is a communication protocol mainly used for high speed data communication, it is possible to communicate with a communication system of either one of the protocols. The communication unit 40 communicates with the base station with one of the protocols by selectively switching a plurality of communication systems, which provide mutually overlapping communication areas based on an instruction from the control unit 30. It should be noted that, the mobile telephone device 1 gives priority to communication using an LTE communication system of an LTE standard (first communication system) at the time of data communication, and switches to communication using a CDMA communication system of a CDMA standard (second communication system) at the time of voice communication or transmission and reception of SMS.

It should be noted that SMS is a function for transmitting and receiving a short message (about several tens of characters) to and from a communication counterpart. This SMS uses communication initiation and communication arrival sequences, which are partly in common with voice communication, and a transmission counterpart is identified with a telephone number in a CDMA communication system.

The storage unit 50 includes a working memory, for example, and is used for arithmetic processing by the control unit 30. In addition, the storage unit 50 stores various programs and the like in accordance with the present embodiment.

The voice control unit 60 performs predetermined voice processing on a signal supplied from the communication unit 40 according to the control of the control unit 30, and outputs to the receiver 22 the signal thus processed. The receiver 22 externally outputs the signal transmitted from the voice control unit 60. It should be noted that this signal may be outputted from a loudspeaker, in place of the receiver 22 or in addition to the receiver 22. In addition, the voice control unit 60 processes the signal inputted from the microphone 12 according to the control of the control unit 30, and outputs to the communication unit 40 the signal thus processed. The communication unit 40 performs predetermined processing on a signal transmitted from the voice control unit 60 and outputs the signal thus processed from the antenna.

Next, the function of the control unit 30 and the control devices of each communication system will be described in detail.

The control unit 30 includes a communication switching unit 31, a connection availability reception unit 32, and a communication initiation processing unit 33. In addition, the control device 110 of the LTE communication system includes a determination unit 111 (first determination unit) and a transmission unit 112. Furthermore, the control device 120 of the CDMA communication system includes a determination unit 121 (second determination unit).

The communication switching unit 31 communicates by selectively switching an LTE communication system and a CDMA communication system and controlling the communication unit 40.

In addition, upon changing the location registering destination between an LTE communication system and a CDMA communication system, the communication switching unit 31 receives supplementary information for changing the connection counterpart from the control device 110 of the LTE communication system, which has knowledge of a locational relationship between a first communication area section (calling zone) in the LTE communication system and a second communication area section in the CDMA communication system.

In a case where voice communication initiation or SMS communication initiation is requested in a situation where a location of the mobile telephone device 1 is registered in the LTE communication system, the connection availability reception unit 32 receives connection non-available information in the LTE communication system in a case where the connection to the destination is not possible.

Here, examples of the case where connection to the destination is not possible include the following cases:
a case where a destination telephone number of voice communication initiation or SMS communication initiation is not valid as a telephone number (unused or inappropriate digit telephone number, or a telephone number containing an invalid character);
a case where the destination of voice communication initiation or SMS communication initiation is out of service or powered OFF, and a location is not registered in the CDMA communication system; and
a case where a communication arrival refusal is set in the destination of voice communication initiation or SMS communication initiation.

In a case where the connection non-available information is not received after the voice communication initiation or SMS communication initiation is requested, the communication initiation processing unit 33 performs voice communication initiation or SMS communication initiation by changing the location registering destination to the CDMA communication system, and in a case where the connection non-available information is received, the state where the location registering destination is the LTE communication system is maintained and the voice communication initiation or SMS communication initiation ends.

The determination unit 111 determines whether or not the format of the destination telephone number is correct (whether or not it matches the digit and the rule of numbers and symbol string) in the control device 110 in the LTE communication system, where voice communication initiation is requested.

If it is determined by the determination unit 111 that there is an error in the destination telephone number, the transmission unit 112 transmits connection non-available information to the mobile telephone device 1 that requested the voice communication initiation or SMS communication initiation, and if it is determined that the destination telephone number is correct, the transmission unit 112 inquires to the control device 120 of the CDMA communication system whether or not connection to the destination is possible.

In addition, if it is determined by the control device 120 (determination unit 121) of the CDMA communication system that connection to the destination is not possible, the transmit unit 112 transmits connection non-available information to the mobile telephone device 1 that requested the voice communication initiation or SMS communication initiation, and if it is determined that connection to the destination is possible, the transmit unit 112 transmits to the mobile telephone device 1 that requested the voice communication initiation or SMS communication initiation a signal that requests to change (handdown) the location registering destination to the CDMA communication system.

In response to an inquiry from the control device 110 (transmission unit 112) of the LTE communication system, the determination unit 121 determines whether or not the connection to the destination is possible in the control device 120 of the CDMA communication system, and replies to the control device 110 of the LTE communication system.

Thereby, in a case where voice communication initiation or SMS communication initiation is requested from the mobile telephone device 1 that is registered as a location in the LTE communication system, the determination unit (determination unit 111 and determination unit 121) determines whether or not the connection to the destination is possible. In addition, this determination result is notified to the mobile telephone device 1 by the transmission unit 112 as connection non-available information or a handdown request.

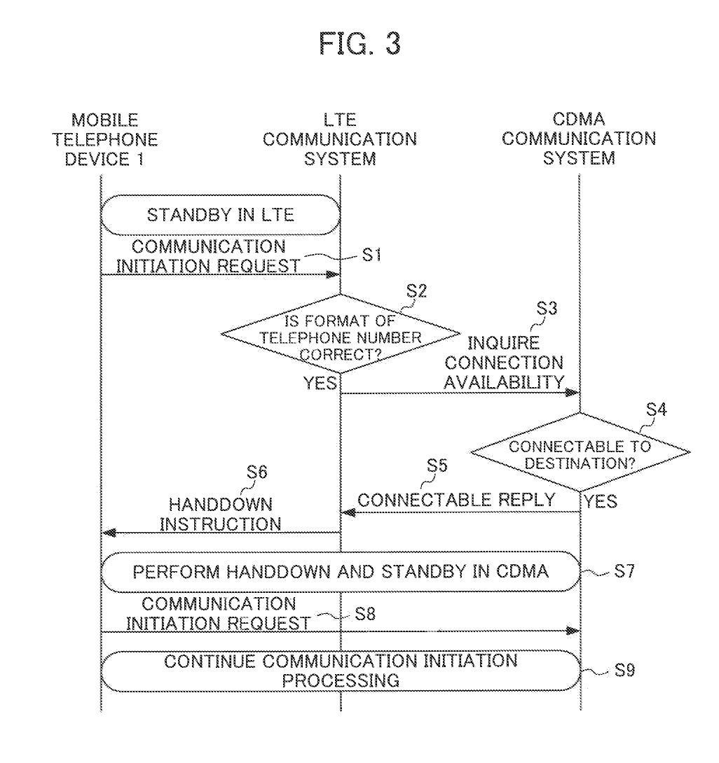

FIG. 3 is a sequence diagram showing a processing flow in the communication control system 100 in a case where voice communication initiation can be performed from the mobile telephone device 1 according to the present embodiment to the terminal at the destination.

It should be noted that the mobile telephone device 1 is in a communication standby state in the LTE communication system. In addition, although voice communication initiation will be described as an example, the same may be described of SMS communication initiation.

In Step S1, the mobile telephone device 1 requests communication initiation of a voice call to the LTE communication system.

In Step S2, the control device 110 (determination unit 111) of the LTE communication system determines whether or not the format of the destination telephone number requested in Step S1 is correct. In this example, it is assumed that the determination is YES.

In Step S3, by notifying identification information (telephone number) of the destination to the CDMA communication system, the control device 110 (transmission unit 112) of the LTE communication system inquires about the connection availability to the destination.

In Step S4, the control device 120 (determination unit 121) of the CDMA communication system determines whether or not connection to the destination that was inquired about in Step S3 is possible. In this example, it is assumed that the determination is YES.

In Step S5, the control device 120 (determination unit 121) of the CDMA communication system replies to the control device 110 of the LTE communication system that connection to the destination is possible.

In Step S6, the control device 110 (transmission unit 112) of the LTE communication system instructs to the mobile telephone device 1 handdown to the CDMA communication system.

In Step S7, the mobile telephone device 1 performs handdown to the CDMA communication system and transfers to a communication standby state in the CDMA communication system.

In Step S8, the mobile telephone device 1 requests communication initiation of a voice call to the CDMA communication system.

In Step S9, the mobile telephone device 1 continues the communication initiation processing in the CDMA communication system.

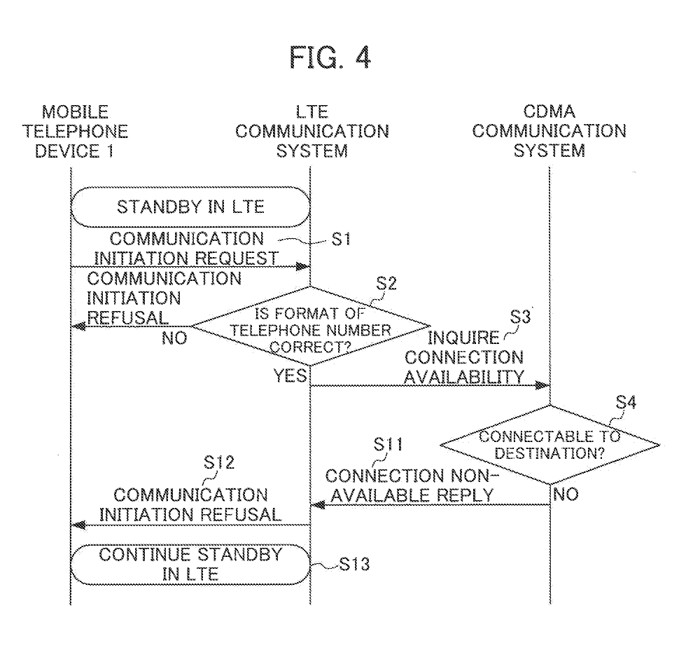

FIG. 4 is a sequence diagram showing a processing flow in the communication control system 100, in a case where a voice communication initiation is not possible from the mobile telephone device 1 according to the present embodiment to the terminal at the destination. It should be noted that the same can be described for SMS communication initiation.

In addition, the mobile telephone device 1 is in a communication standby state in the LTE communication system. Furthermore, the same reference numeral is assigned to the same step in FIG. 3.

In Step S1, the mobile telephone device 1 requests communication initiation of a voice call to the LTE communication system.

In Step S2, the control device 110 (determination unit 111) of the LTE communication system determines whether or not the format of the telephone number of the destination requested in Step S1 is correct. If this determination is YES, the process moves to Step S3, and if the determination is NO, the transmission unit 112 notifies a communication initiation refusal to the mobile telephone device 1.

In Step S3, by notifying identification information (telephone number) of the destination to the CDMA communication system, the control device 110 (transmission unit 112) of the LTE communication system inquires about the connection availability to the destination.

In Step S4, the control device 120 (determination unit 121) of the CDMA communication system determines whether or not connection to the destination that was inquired about in Step S3 is possible. In this example, it is assumed that determination is NO.

In Step S11, the control device 120 (determination unit 121) of the CDMA communication system replies to the control device 110 of the LTE communication system that connection to the destination is not possible.

In Step S12, the control device 110 (transmission unit 112) of the LTE communication system notifies to the mobile telephone device 1 of a refusal of the communication initiation.

In Step S13, since the voice call cannot be placed with the destination, the mobile telephone device 1 continues the communication standby state in the LTE communication system.

### Second Embodiment

Hereafter, the second embodiment of the present invention will be described. It should be noted that, in the present embodiment, processing of the determination unit 121 in the control device 120 of the CDMA communication system is different from the first embodiment.

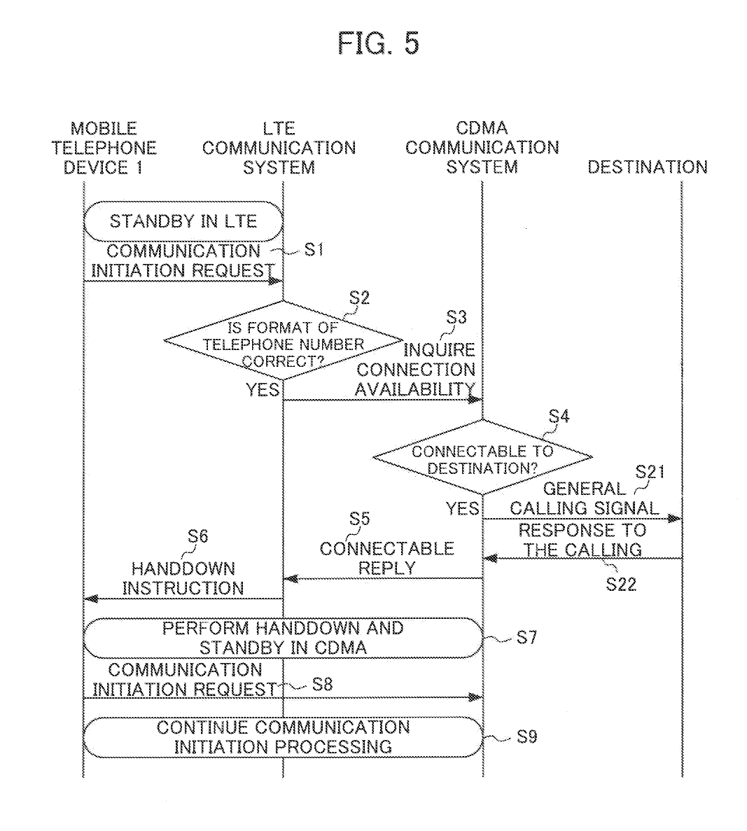

FIG. 5 is a sequence diagram showing a processing flow in the communication control system 100 in a case where voice communication initiation or SMS communication initiation is possible from the mobile telephone device 1 according to the present embodiment to the destination terminal.

It should be noted that the mobile telephone device 1 is in a communication standby state in the LTE communication system. In addition, the same reference numeral is assigned to the same step as the first embodiment (FIG. 3).

Steps S1-S4 are the same as that of the first embodiment, and the connection availability to the destination is determined by the determination unit 111 and the determination unit 121 according to a communication initiation request from the mobile telephone device 1.

In Step S21, the control device 120 (determination unit 121) of the CDMA communication system transmits to the connected terminal (mobile telephone device) a general calling signal of a voice call or SMS reception.

In Step S22, the control device 120 (determination unit 121) of the CDMA communication system receives a call response from the connected terminal (mobile telephone device). Thereby, the determination unit 121 determines that connection to the destination is possible.

Steps S5-S9 are the same as that of the first embodiment, and handdown is instructed from the LTE communication system to the mobile telephone device 1, and the mobile telephone device 1 continues communication initiation processing in the CDMA communication system.

It should be noted that, in a case where a call response is not received in Step S22, a communication initiation refusal is notified to the mobile telephone device 1 with the same processing as Steps S11-S13 in FIG. 4, the mobile telephone device 1 continues a communication standby state in the LTE communication system.

As described above, according to the above-described embodiment, the mobile telephone device 1 receives an instruction of handdown from the LTE communication system in a case where it is determined that connection to the destination is possible. Therefore, the mobile telephone device 1 does not perform handdown if connection to the destination or SMS transmission is not possible.

Here, conventional voice communication initiation processing using the CS-Fallback function will be shown for comparison.

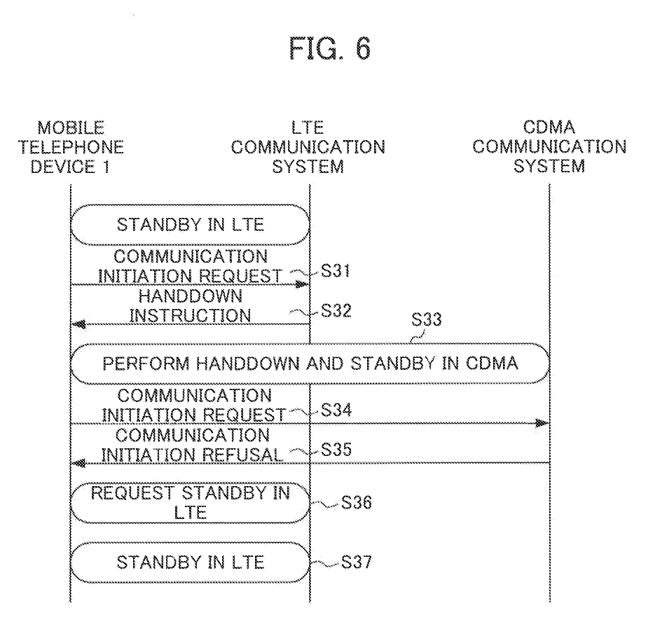

As shown in FIG. 6, when requesting communication initiation or SMS transmission to the LTE communication system (Step S31), the mobile telephone device 1 is instructed of handdown from the LTE communication system (Step S32). Then, after performing handdown to the CDMA communication system and becoming in a communication standby state in the CDMA communication system (Step S33), the mobile telephone device 1 requests communication initiation to the CDMA communication system (Step S34). At this time, since a communication initiation refusal (transmission error) is notified from the CDMA communication system to the mobile telephone device 1 in a case where the connection to the destination or SMS transmission is not possible (Step S35), the mobile telephone device 1 requests a standby in the LTE communication system again (Step S36) and transfers to a communication standby state in the LTE communication system (Step S37).

Accordingly, when the mobile telephone device 1 performs handdown immediately in response to a communication initiation request, processing in Steps S32-S36 becomes useless in a situation where the destination cannot reply.

Thus, according to the above-described embodiment, since the mobile telephone device 1 does not perform an unnecessary handdown, it is possible to avoid inconveniences related to switching of the communication systems, such as unnecessary consumption of unnecessary wireless resources, consumption of electricity, and additional waiting time, and thus it is possible to communicate more comfortably.

In addition, according to the above-described embodiment, since the determination unit 111 is provided in the control device 110 of the LTE communication system, there are cases when the communication control system 100 can determine that the communication to the destination is not possible without inquiring to the CDMA communication system. Therefore, the communication control system 100 can reduce processing load or network load furthermore.

In addition, in accordance with the second embodiment, since the existence of response can be determined by performing a general calling to the destination terminal, the determination unit 121 can determine the availability of the connection or SMS transmission to the destination more correctly.

Although the embodiments of the present invention have been described in the above, the present invention is not limited to the embodiments described above. In addition, the effects described for the embodiments of the present invention are merely a result of exemplifying effects arising from the present invention, and the effects of the present invention are not limited to those described for the embodiments of the present invention.

The first communication system is not limited to those of an LTE standard, and for example, it may be of a WiMAX standard, or the like, and the present invention is applicable as long as a function corresponding to the CS-Fallback can be implemented with regard to communication initiation processing.

In addition, the wireless terminal device according to the present invention is not limited to a mobile telephone device 1. The present invention is applicable to various devices, such as a PHS (trademark: Personal Handyphone System), a PDA (Personal Digital Assistant), a gaming device, a navigation device, a personal computer, and a communication-dedicated module specialized in communication functions.

What is claimed is:

1. A wireless terminal device comprising:
a communication switching unit for selectively switching communication between a first communication system and a second communication system;
a connection information reception unit for receiving connection non-available information in the first communication system in a case where connection to a destination is not possible, upon communication initiation being requested in a situation where location registration is performed in the first communication system; and
a communication initiation processing unit which, after the communication initiation is requested, in a case where the connection non-available information is not received, performs the communication initiation by changing a location registering destination to the second communication system, and in a case where the connection non-available information is received, maintains a state where the location registering destination is the first communication system and ends communication initiation processing.

2. The wireless terminal device according to claim 1, wherein
upon changing the location registering destination between the first communication system and the second communication system, the communication switching unit receives from a control device of the first communication system that has knowledge of a locational relationship between a first communication area section in the first communication system and a second communication area section in the second communication system, supplementary information for changing a connection counterpart.

3. The wireless terminal device according to claim 1, wherein
the case where connection to a destination is not possible is a case where a destination telephone number is not valid as a telephone number.

4. The wireless terminal device according to claim 1, wherein
the case where connection to a destination is not possible is a case where the destination is not registered as a location in the second communication system.

5. The wireless terminal device according to claim 1, wherein
the case where connection to the destination is not possible is a case where the destination has set a communication arrival refusal.

6. The wireless terminal device according to claim 1, wherein
the case where connection to the destination is not possible is a case where the destination cannot reply to a call.

7. The wireless terminal device according to claim 1, wherein
the communication initiation is voice communication initiation.

8. The wireless terminal device according to claim 1, wherein
the communication initiation is SMS (short message service) transmission.

9. The wireless terminal device according to claim 1, wherein
the first communication system is of a WiMAX standard, and the second communication system is of a CDMA standard.

10. The wireless terminal device according to claim 2, wherein
the first communication system is of an LTE standard, the second communication system is of a CDMA standard, and
the reception of the supplementary information complies with a CS-Fallback function defined in 3GPP TS 23.272.

11. A communication control system for connecting between a plurality of wireless terminal devices by selectively switching between a first communication system and a second communication system according to a communication request from a wireless terminal device, the communication control system comprising:
a determination unit for determining whether or not communication to a destination is possible upon communication initiation being requested from a wireless terminal device that is registered as a location in the first communication system; and
a transmission unit which, in a case where it is determined that connection to the destination is not possible by the determination unit, transmits connection non-available information to the wireless terminal device that requested the communication initiation, and in a case where it is determined that connection to the destination is possible, transmits to the wireless terminal device that requested the communication initiation a signal that requests to change the location registering destination to the second communication system.

12. The communication control system according to claim 11, wherein
the determination unit includes: a first determination unit for determining correctness of a format of a destination telephone number, in a control device of the first communication system that requested the communication initiation; and a second determination unit for determining whether or not connection to the destination is possible according to an inquiry from the control device of the first communication system, in a control device of the second communication system.

13. The communication control system according to claim 12, wherein
the second determination unit transmits a calling signal to the destination, and in a case where a response to the calling signal is received, determines that connection to the destination is possible, and in a case where a response to the calling signal is not received, determines that connection to the destination is not possible.

14. A communication control method in a wireless terminal device, comprising:
a communication switching step of selectively switching communication between a first communication system and a second communication system;
a connection information receiving step of receiving connection non-available information in the first communication system in a case where connection to a destination is not possible, upon communication initiation being requested in a situation where location registration is performed in the first communication system; and
a communication initiation processing step which, after the communication initiation is requested, in a case where the connection non-available information is not received, performs the communication initiation by changing a location registering destination to the second communication system, and in a case where the connection non-available information is received, maintains a state where the location registering destination is the first communication system and ends communication initiation processing.
